(19) United States
(12) Patent Application Publication
(10) Pub. No.: US 2018/0079948 A1
(43) Pub. Date: Mar. 22, 2018

(54) Bead Suspension Mixing with Cement Slurry

(71) Applicant: Halliburton Energy Services, Inc., Houston, TX (US)

(72) Inventors: Paul Mendenall, Duncan, OK (US); Chad Brenneis, Marlow, OK (US); Rickey Morgan, Duncan, OK (US)

(73) Assignee: Halliburton Energy Services, Inc., Houston, TX (US)

(21) Appl. No.: 15/569,662

(22) PCT Filed: Apr. 28, 2015
(86) PCT No.: PCT/US2015/027870

§ 371 Date: Oct. 26, 2017

(51) Int. Cl. C09K 8/473; C04B 28/02; C04B 18/02; C04B 40/00; E21B 47/00; E21B 33/14

(52) U.S. Cl. CPC C09K 8/473; C04B 28/02; C04B 18/027; C04B 2111/00146; E21B 47/0005; E21B 33/14; C04B 40/0032

(57) ABSTRACT

A method to mix cement includes preparing a bead suspension comprising beads and preparing a cement slurry separately from the bead suspension, the cement slurry including a cement blend. The method further includes mixing the bead suspension and the cement slurry to create a mixture and pumping the mixture into a well.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

Oil field operations often involve the blending of dry materials with a fluid, such as water or another liquid or gas. For instance, dry materials may be added to a fluid when preparing a cement slurry, a fracturing fluid, a drilling fluid, or other slurries utilized in subterranean operations. High pressure pumps are then used to pump the slurry to a desired location downhole.

For example, to exclude fluids from the annular space around a casing string or other pipe placed in the well, a cement slurry is placed in the annular space and the cement slurry, after setting thereof, will seal the passage through the annulus and bond the casing string to the wall of the well. The cement slurry may be pumped directly into the annulus, or may first be passed downwards through the casing string (or through a special cementing tube suspended in the string) and subsequently upwards through the annular space around the casing string.

During the cementing operations, the pressure at each level of the annulus should be less than the fracturing pressure at the relevant depth level, as the formation will otherwise be fractured and the cement slurry will pass into the formation rather than filling up the annulus around the casing. To obviate this problem, such as when cementing wells that penetrate underground formations located below a body of water (e.g., a sea or ocean), a lightweight-type cement may be used. The cement slurries of the lightweight type have a density that is considerably lower than the density of the normal cement slurries, such as in the range of 900-1900 kg/m3, whereas the density of a normal cement slurry is about 1920 kg/m3. To create a lightweight-type cement, low-density granular material or gas is included with the cement. For example, the granular material is mixed with the dry cement blend, with liquid then added to the dry materials and the ratio of the materials and liquid controlled so that the slurry has the concentration or density desired downhole. Depending on the job rate, however, the equipment needed (e.g., the mixing tub, the tub level valve, the slurry pump, etc.) for creating the mixture are often bulky and consume a large amount of energy. Further, the slurry may still have irregularities with respect density and being homogeneous.

### BRIEF DESCRIPTION OF THE DRAWINGS

Illustrative embodiments of the present disclosure are described in detail below with reference to the attached drawing figures, which are incorporated by reference herein and wherein:

FIG. 1 shows an illustrative cementing environment in which a structure is supported on the seabottom in accordance with one or more embodiments of the present disclosure; and

FIG. 2 shows a schematic view of a system 200 to mix cement in accordance with one or more embodiments of the present disclosure.

The illustrated figures are only exemplary and are not intended to assert or imply any limitation with regard to the environment, architecture, design, or process in which different embodiments may be implemented.

### DETAILED DESCRIPTION OF ILLUSTRATIVE EMBODIMENTS

The following discussion is directed to various embodiments of the present disclosure. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but are the same structure or function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

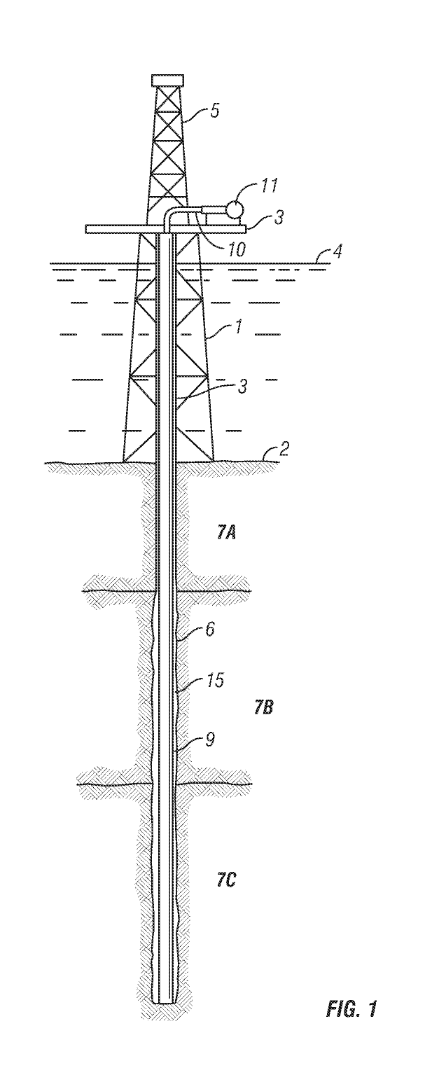

Turning now to the present figures, FIG. 1 shows an illustrative cementing environment, in which a structure 1 in this embodiment is supported on the sea bottom 2. The structure 1 supports a platform 3 at some distance above the sea level 4. A drilling rig 5 is carried by the platform 3, and a hole 6 (e.g., borehole or well) has been drilled in the formations 7A, 7B and 7C below the sea bottom 2. The hole 6 has been drilled by drilling equipment (not shown), such as a drill string with a drill bit attached thereto that is lowered into the formations 7 via a conductor string that is supported from the platform 3. After the hole 6 has reached a desired depth, the drilling equipment is lifted from the hole 6 and a casing string 9 is lowered into the hole and suspended from the platform 3. The inlet to the casing string 9 is subsequently brought into communication with a cement pump 11 using a conduit 10. The pump 11 can draw cement slurry from a (not shown) suitable source of cement slurry, in which the cement slurry is forced by the pump 11 into the casing string 9 via the conduit 10.

Accordingly, various methods, systems, and tools are disclosed to mix cement, and more particularly mix a bead suspension with a cement slurry. A bead suspension may include beads mixed or suspended in a liquid, such as water, with the beads having a low density. As such, a bead in accordance with the present disclosure may include a lightweight-type bead, a hollow bead, an empty-shell bead, a low-gravity bead, and/or a glass bead. The cement slurry may include a cement blend (e.g., a dry blend) that is mixed or suspended also in a liquid, such as water. The cement slurry may also include one or more additives, such as depending on the application for the cement slurry. The density of the bead suspension may be lower than that of the cement slurry such that, when the bead suspension is mixed with the cement slurry, the remaining mixture or cement slurry may then have an overall lower density. The bead suspension may then be used to create a lightweight-type cement or cement slurry.

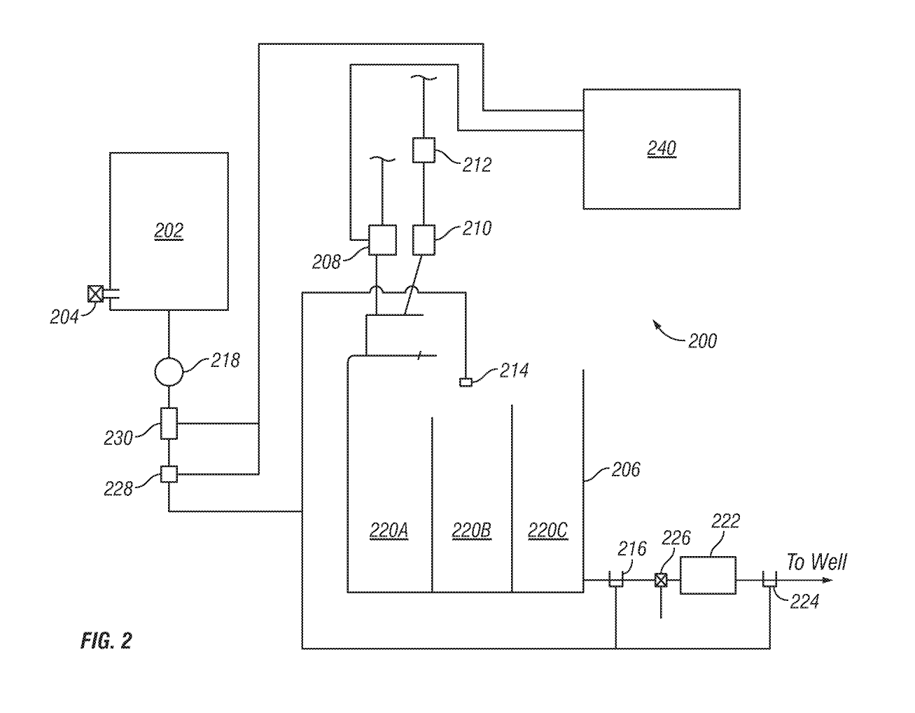

Referring now to FIG. 2, a schematic view of a system 200 to mix cement is shown in accordance with one or more embodiments of the present disclosure. The system 200 includes a bead suspension tank 202 to prepare, mix, and/or contain the bead suspension, in which the system 200 may be used within a land based environment and/or offshore. For example, the beads and liquid may be combined at desired ratios within the bead suspension tank 202 to create or prepare a bead suspension with a desired density. A sensor 204 may also be coupled to or in fluid communication with the bead suspension tank 202, such as to measure and monitor the density of bead suspension within the bead suspension tank 202.

The system 200 further includes one or more mixing tanks 206, or a mixing tank with multiple sections. In this embodiment, the mixing tank 206 will be discussed as including one or more sections. However, those having ordinary skill in the art will appreciate that the sections of the mixing tank 206 may be replaced by other mixing tanks. The mixing tank 206 may be used to prepare, mix, and/or contain the cement slurry. For example, a cement blend may be selectively introduced into the mixing tank 206 through a valve 208, and liquid (e.g., water) may be selectively introduced into the mixing tank 206 through another valve 210. Further, the flow of the liquid through the valve 210 may be measured using a flowmeter 212. The cement blend and liquid may be combined at desired rations within the mixing tank 206 to create or prepare the cement slurry with a desired density. In one or more embodiment, the mixing tank 206 may include paddle stirrers and/or a recirculating mixer, such as to recirculate and maintain a homogenous mixture or solution within the mixing tank 206. A sensor may also be coupled to or in fluid communication with the mixing tank 206 (or to each mixing tank or section of the mixing tank), such as to measure and monitor the density of cement slurry within the mixing tank 206.

To prepare a mixture or a cement slurry in accordance with the present disclosure, the bead suspension may be combined and mixed with the cement slurry, such as to create a lightweight-type cement or cement slurry. In one embodiment, the bead suspension may be mixed with the cement slurry within the mixing tank 206, or may be mixed with the cement slurry at a point downstream of the mixing tank 206. For example, the bead suspension may be pumped from the bead suspension tank 202 to an outlet 214 in the mixing tank 206. Additionally or alternatively, the bead suspension may be pumped from the bead suspension tank 202 to an outlet 216 (e.g., into a conduit) downstream of the mixing tank 206, or an outlet 224 downstream of a pump 222.

As mentioned above and as shown in the embodiment in FIG. 2, the mixing tank 206 may include one or more sections, such as a first section 220A, a second section 220B, and a third section 220C in this embodiment. Additionally or alternatively, one or more of the sections may be replaced by mixing tanks. In this embodiment, the cement slurry may be prepared from the cement blend and liquid in the first section 220A of the mixing tank 206. This may be referred to as the base cement slurry (e.g., cement slurry without any bead suspension included therewith). As the sections of the mixing tank 206 may be in fluid communication with each other, the cement slurry from the first section 220A (or at least some) may be pumped or spill over into the second section 220B of the mixing tank 206.

The bead suspension may be pumped from the bead suspension tank 202 to the outlet 214 and into the first section 220A, the second section 220B, and/or the third section 220C of the mixing tank 206. As such, a mixture or a lighter weight cement slurry may be created or mixed from the bead suspension and the cement slurry in any of the three sections of the mixing tank 206. In one or more embodiments, the mixture or cement slurry from the second section 220B (or at least some) may then be pumped or spill over into the third section 220C of the mixing tank 206. In such an embodiment, the mixture or cement slurry in the third section 220C of the mixing tank 206 may be lighter and have a lower density than that in the second section 220B of the mixing tank 206. Further, the mixture or cement slurry in the second section 220B of the mixing tank 206 may be lighter and have a lower density than that in the first section 220A of the mixing tank 206.

A pump 222 may be used to pump the contents (e.g., mixture or cement slurry) from the mixing tank 206 downhole to a well. The pump 222 may be a high pressure pump (e.g., operating pressures between about 0 and about 20,000 psi), and in this embodiment, the pump 222 may be fluidly coupled to the third section 220C of the tank to pump the mixture or cement slurry from the third section 220C downhole to a well. Further, a pump 218 may be used to pump the bead suspension out from the bead suspension tank 202. In the embodiment in which the pump 218 is used to pump the bead suspension to the outlet 214 into the mixing tank 206 or to the outlet 216 to a point downstream of the mixing tank 206 (and upstream of the pump 222), the pump 218 may be a low pressure pump (e.g., operating pressures between about 0 and about 150 psi). In another embodiment, the pump 218 may be used to pump the bead suspension to an outlet 224 and a point downstream of the pump 222. In such an embodiment, the pump 218 may then be a high pressure pump to join the flow from the high pressure pump 222.

A sensor 226 may be coupled to or in fluid communication with an output of the mixing tank 206 and/or a suction side of the pump 222, such as to measure and monitor the density of mixture or cement slurry that is pumped downhole to the well. One or more control valves 228 may be used to selectively control the flow of the bead suspension from the bead suspension tank 202 to the outlets 214, 216, and/or 224. Further, the flow of the bead suspension out from the bead suspension tank 202 may be measured using a flowmeter 230.

Referring still to FIG. 2, a system 200 in accordance with the present disclosure may include a controller 240, such as to monitor and/or control one or more components within the system 200. In particular, the controller 240 may be used to monitor and control a density of the mixture or cement slurry that is pumped into the well using the system 200. For example, a predetermined or desired downhole density for the mixture or cement slurry to be pumped downhole into the well may be known (e.g., an operator may enter the predetermined or desired downhole density into the controller 240 or a component in communication with the controller 240). The controller 240 may be used to compare the predetermined downhole density with that measured for the mixture or cement slurry in the system 200, and then the controller 240 may be used to control one or more components within the system 200 based upon the comparison of the predetermined downhole density with the measured density. The controller 240 may be in communication with one or more of the sensors and flowmeters in the system 200, and may use information from these components to then monitor and control a density of the mixture or cement slurry that is pumped into the well using the system 200.

For example, in an embodiment in which the measured density for the mixture or cement slurry is above that for (e.g., heavier than) the predetermined downhole density, then the controller 240 may be used to introduce and add more of the bead suspension to the mixture or cement slurry until a desired density is met or achieved. This may have the effect of lowering the density of the mixture or cement slurry that is pumped downhole to the well. In an embodiment in which the measured density for the mixture or cement slurry is lower than (e.g., lighter than) the predetermined downhole density, then the controller 240 may be used to introduce and add more of the cement slurry or cement blend to the mixture or cement slurry until desired. This may have the effect of raising the density of the mixture or cement slurry that is pumped downhole to the well. The controller 240 may include electrical components, hardware, software, and as this is a hydraulic environment, may include hydraulic components (e.g., hydraulic actuators and/or valves). As such, as the controller 240 may know a density of the bead suspension, a density of the cement slurry, and the predetermined downhole density, the controller 240 may calculate desired ratios of the bead suspension and cement slurry for mixing a mixture or cement slurry having the desired density.

In addition to the embodiments described above, many examples of specific combinations are within the scope of the disclosure, some of which are detailed below:

### EXAMPLE 1

A method to mix cement, the method comprising:
preparing a bead suspension comprising beads;
preparing a cement slurry separately from the bead suspension, the cement slurry comprising a cement blend;
mixing the bead suspension and the cement slurry to create a mixture; and pumping the mixture into a well.

### EXAMPLE 2

The method of Example 1, wherein the bead suspension is prepared in a bead suspension tank.

### EXAMPLE 3

The method of Example 2, wherein the cement slurry is prepared in a mixing tank separate from the bead suspension tank.

### EXAMPLE 4

The method of Example 3, wherein the mixing the bead suspension and the cement slurry comprises pumping the bead suspension from the bead suspension tank into the mixing tank.

### EXAMPLE 5

The method of Example 4, wherein the mixture is pumped into the well using a high pressure pump, and wherein the bead suspension is pumped into the mixing tank using a low pressure pump.

### EXAMPLE 6

The method of Example 3, wherein the mixing the bead suspension and the cement slurry comprises pumping the bead suspension from the bead suspension tank to a point downstream of the mixing tank.

### EXAMPLE 7

The method of Example 3, wherein the mixing tank comprises a recirculating mixer.

### EXAMPLE 8

The method of Example 1, further comprising measuring a density of the bead suspension.

### EXAMPLE 9

The method of Example 1, further comprising:
measuring a density of the mixture;
comparing the measured density of the mixture with a predetermined downhole density for the mixture; and
adding more bead suspension to the mixture if the measured density of the mixture is above the predetermined downhole density for the mixture.

### EXAMPLE 10

The method of Example 9, wherein the density of the bead suspension is lower than that of the cement slurry.

### EXAMPLE 11

The method of Example 1, wherein the bead suspension comprises the beads and liquid, and wherein the cement slurry comprises the cement blend and liquid.

### EXAMPLE 12

A system to mix cement, comprising:
a bead suspension tank to contain a bead suspension comprising beads;
a mixing tank separate from the bead suspension tank to contain a cement slurry comprising a cement blend;
a pump to pump a mixture of the bead suspension and the cement slurry into a well.

### EXAMPLE 13

The system of Example 12, wherein the pump comprises a high pressure pump.

### EXAMPLE 14

The system of Example 13, wherein the system further comprises a low pressure pump to pump the bead suspension when mixing the bead suspension and the cement slurry to create the mixture.

### EXAMPLE 15

The system of Example 14, wherein the low pressure pump is used to pump the bead suspension into the mixing tank.

### EXAMPLE 16

The system of Example 14, wherein the low pressure pump is used to pump the bead suspension to a point downstream of the mixing tank.

### EXAMPLE 17

The system of Example 12, further comprising a sensor to measure a density of the mixture.

### EXAMPLE 18

The system of Example 12, further comprising a controller to control a density of the mixture based upon a comparison of the measured density of the mixture and a predetermined downhole density for the mixture.

### EXAMPLE 19

The system of Example 12, wherein the mixing tank comprises a recirculating mixer.

### EXAMPLE 20

A method to mix cement, the method comprising:
measuring a density of a cement slurry comprising a cement blend;
comparing the measured density of the cement slurry with a predetermined downhole density for the cement slurry; and
adding a bead suspension comprising beads to the cement slurry if the measured density of the cement slurry is above the predetermined downhole density for the cement slurry.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method to mix cement, the method comprising:
preparing a bead suspension comprising beads;
preparing a cement slurry separately from the bead suspension, the cement slurry comprising a cement blend;
mixing the bead suspension and the cement slurry to create a mixture; and
pumping the mixture into a well.

2. The method of claim 1, wherein the bead suspension is prepared in a bead suspension tank.

3. The method of claim 2, wherein the cement slurry is prepared in a mixing tank separate from the bead suspension tank.

4. The method of claim 3, wherein the mixing the bead suspension and the cement slurry comprises pumping the bead suspension from the bead suspension tank into the mixing tank.

5. The method of claim 4, wherein the mixture is pumped into the well using a high pressure pump, and wherein the bead suspension is pumped into the mixing tank using a low pressure pump.

6. The method of claim 3, wherein the mixing the bead suspension and the cement slurry comprises pumping the bead suspension from the bead suspension tank to a point downstream of the mixing tank.

7. The method of claim 3, wherein the mixing tank comprises a recirculating mixer.

8. The method of claim 1, further comprising measuring a density of the bead suspension.

9. The method of claim 1, further comprising:
measuring a density of the mixture;
comparing the measured density of the mixture with a predetermined downhole density for the mixture; and
adding more bead suspension to the mixture if the measured density of the mixture is above the predetermined downhole density for the mixture.

10. The method of claim 9, wherein the density of the bead suspension is lower than that of the cement slurry.

11. The method of claim 1, wherein the bead suspension comprises the beads and liquid, and wherein the cement slurry comprises the cement blend and liquid.

12. A system to mix cement, comprising:
a bead suspension tank to contain a bead suspension comprising beads;
a mixing tank separate from the bead suspension tank, the mixing tank to contain a cement slurry comprising a cement blend; and
a pump to pump a mixture of the bead suspension and the cement slurry into a well.

13. The system of claim 12, wherein the pump comprises a high pressure pump.

14. The system of claim 13, wherein the system further comprises a low pressure pump to pump the bead suspension when mixing the bead suspension and the cement slurry to create the mixture.

15. The system of claim 14, wherein the low pressure pump is used to pump the bead suspension into the mixing tank.

16. The system of claim 14, wherein the low pressure pump is used to pump the bead suspension to a point downstream of the mixing tank.

17. The system of claim 12, further comprising a sensor to measure a density of the mixture.

18. The system of claim 12, further comprising a controller to control a density of the mixture based upon a comparison of the measured density of the mixture and a predetermined downhole density for the mixture.

19. The system of claim 12, wherein the mixing tank comprises a recirculating mixer.

20. A method to mix cement, the method comprising:
measuring a density of a cement slurry comprising a cement blend;
comparing the measured density of the cement slurry with a predetermined downhole density for the cement slurry; and
adding a bead suspension comprising beads to the cement slurry if the measured density of the cement slurry is above the predetermined downhole density for the cement slurry.
